(19) United States
(12) Patent Application Publication
(10) Pub. No.: US 2006/0225501 A1
(43) Pub. Date: Oct. 12, 2006

(54) Lever-type sender for a fuel tank

(76) Inventors: Benoît Bahl, Gotzenbruch (FR); Michael Bessling, Essen (DE)

Correspondence Address: MAYER, BROWN, ROWE & MAW LLP, P.O. BOX 2828, CHICAGO, IL, 60690-2828, US

(21) Appl. No.: 10/568,935

(22) PCT Filed: Jul. 15, 2004
(86) PCT No.: PCT/EP04/51503

§ 371 Date: Apr. 13, 2006

(30) Foreign Application Priority Data
Aug. 27, 2003 (DE) 103 39 767.1

(51) Int. Cl. G01F 23/36

(52) U.S. Cl. 73/313; 73/314; 73/317

(57) ABSTRACT

The invention relates to a lever-type sender (8) for a fuel tank (1), which is characterized in that a support (12) comprises a base (14) to be mounted in the fuel tank (1) and a cover (15) linked with said base (14). The base (14) and the cover (15) are provided with a guiding device for a hoop (11) linked with a float. The lever-type sender (8) is reliably protected from damages and has an especially simple design.

### BACKGROUND OF THE INVENTION

The invention relates to a lever-type transmitter for a fuel tank, having a support which is provided in the fuel tank for fastening purposes, having a float which tracks the level of fuel in the fuel tank, and having a bracket which is mounted on the support and is connected to the float, and having an electrical detection unit for generating electrical signals as a function of the position of the bracket.

Lever-type transmitters of this kind are frequently used in modern motor vehicles and are known from industry. In the known lever-type transmitter, the support has a guide for the bracket, which guide is spaced apart from the bearing system. The electrical detection unit is usually a potentiometer or a magnetic position sensor and is arranged between the guide and the bearing system. The result of this is that a sliding contact, which is fastened to the bracket, or a magnet is reliably prevented from being lifted by the other components of the electrical detection unit. The lever-type transmitter may also be premounted to form a physical detection unit and then be fastened to the support in the fuel tank, for example on a splash pot which is arranged in said fuel tank.

One disadvantage of the known lever-type transmitter is that the bracket and the electrical detection unit may be damaged while being installed in the fuel tank, for example. Furthermore, the bracket and the electrical detection unit are exposed to pronounced forces when fuel is sloshing around in the fuel tank.

The invention is based on the problem of developing a lever-type transmitter of the kind mentioned in the introduction in such a way that the bracket and the electrical detection unit are reliably protected against damage and forces caused by fuel sloshing around.

### BRIEF DESCRIPTION OF THE INVENTION

According to the invention, this problem is solved in that the support has a base body and an enclosure which is connected to the base body, and in that the base body is provided in the fuel tank for fastening purposes.

On account of this design, the bracket and the electrical detection unit are enclosed and thus protected against being damaged. The enclosure is therefore able to absorb shocks which occur during installation in the fuel tank, and keep forces produced by fuel sloshing around during operation of the inventive lever-type transmitter away from the bracket and the electrical detection unit. The lever-type transmitter according to the invention is thus reliably protected against being damaged. Components of the electrical element, for example sliding tracks or magnetic sensors, may be arranged on the base body.

According to one advantageous development of the invention, a further contribution is made to improving protection of the electrical detection unit if the enclosure has a cover, and if the base body has an edge which rests against adjacent regions of the cover.

Installation of the lever-type transmitter according to the invention is particularly simple if the connection of the cover to the base body has a latching connection.

According to another advantageous development of the invention, the cover can be easily released after installation on the base body if latching hooks of the base body pass through recesses in the cover.

According to another advantageous development of the invention, the bearing system of the bracket is particularly highly stable if the base body and the cover have a bearing pin and/or a bearing shell for the bracket. The bracket and the cover can thus be installed in the same direction, and this makes automatic installation possible.

According to another advantageous development of the invention, sliding contacts, which are fitted to the bracket, or magnets of the electrical element are reliably prevented from being lifted by components of the electrical element, which are fitted on the base body, if the cover and the base body together have an axial bearing for the bracket.

Similarly to the known lever-type transmitter, a guide element could be arranged on the base body in order to guide the bracket in a position which is spaced apart from its bearing system. However, the lever-type transmitter according to the invention has a particularly low number of components if the base body and the cover together have an axial guide for the bracket, which guide is spaced apart from the bearing system of the bracket.

According to another advantageous development of the invention, the cover can be reliably oriented with respect to the base body in a simple manner if the cover and the base body have positioning pins and positioning recesses which correspond with one another.

In a further advantageous refinement, clamping elements which serve as strain relief means can be avoided on the support if the cables for the electrical detection unit are fixed between the cover and the base body when said cover is fitted.

### BRIEF DESCRIPTION OF THE DRAWINGS

The invention permits numerous embodiments. In order to further explain the basic principle of the invention, one of these embodiments is illustrated in the drawing and described below. In the drawing:

FIG. 1 shows a sectional illustration of a fuel tank with a lever-type transmitter according to the invention,

FIG. 2 shows an enlarged sectional illustration through the lever-type transmitter according to the invention from FIG. 1, and

FIG. 3 shows a perspective illustration of the lever-type transmitter according to the invention before installation.

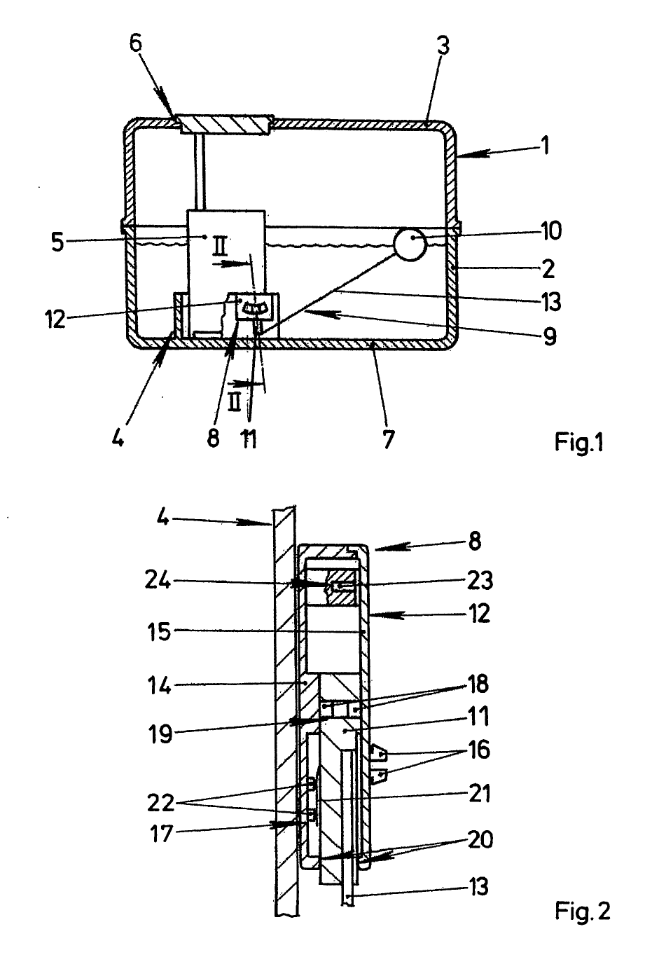

FIG. 1 shows a fuel tank 1 with two half-shells 2, 3 which are welded to one another, and a splash pot 4 which is arranged therein. The upper half-shell 3 has an opening 6 which is provided for inserting a delivery unit 5 into the fuel tank 1. The delivery unit 5 is prestressed against the bottom 7 of the fuel tank 1 and sucks fuel out of the splash pot 4. The fuel tank 1 also has a lever-type transmitter 8 with a float 10 which is fastened to a lever arm 9. The lever arm 9 is pivotably mounted, with a plastic bracket 11, on a support 12 which is fastened on the outside of the splash pot 4 and is provided with the float 10 by means of a bracket wire 13. The float 10 tracks the level of fuel in the fuel tank 1 and in the process pivots the lever arm 9.

FIG. 2 shows an enlarged sectional illustration through the lever-type transmitter 8 from FIG. 1 in that the support 12 has a base body 14 with a cover 15 fastened to it. The cover 15 is fastened to the base body 14 by means of latching hooks 16. The pivot angle of the bracket 11 is detected by an electrical detection unit 17 which is in the form of a potentiometer. The electrical detection unit 17 may, of course, also have a magnetic position sensor. In order to bear the bracket 11, the base body 14 and the cover 15 have bearing pins 18 which enter a hole 19 in the bracket 11. Furthermore, the cover 15 and the base body 14 together form an axial bearing for the bracket 11. The base body 14 and the cover 15 have an axial guide 20 for the bracket 11 in the region in which the bracket 11 protrudes out of the support 12. This prevents a contact plate 21 or a magnet of the electrical detection unit 17 being lifted from conductor tracks 22 which are arranged on the base body 14. The cover 15 and the base body 14 are also centered with respect to one another by positioning pins 23 and positioning recesses 24 which correspond to one another.

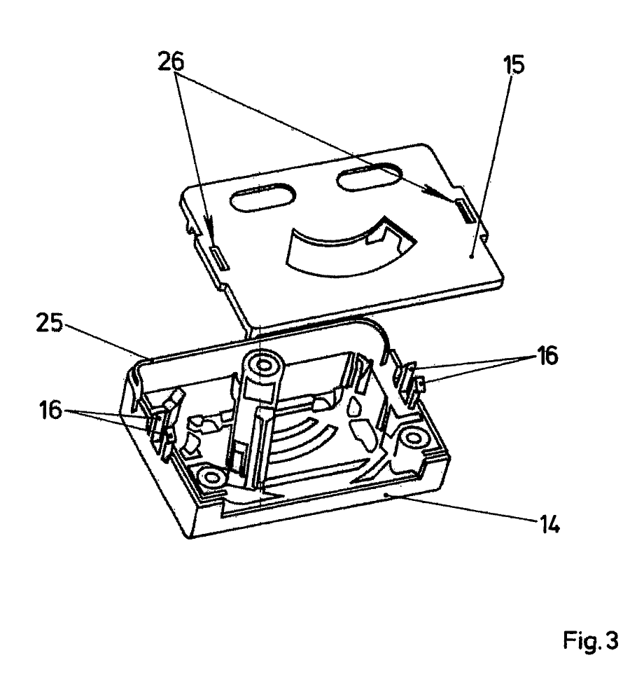

FIG. 3 shows the lever-type transmitter 8 before the cover 15 is fitted on the base body 14. In order to simplify the drawing, the bracket wire 13 from FIG. 1 is not shown. It can be seen in this figure that the base body 14 has an edge 25 for receiving the cover 15, which edge is interrupted by the axial guide 20 for the bracket 11. FIG. 3 also shows that the latching hooks 16 are opposite the cover 15 in the region of recesses 26. Following installation, the latching hooks 16 pass through the recesses 26 and engage behind their edges.

1. A lever-type transmitter for a fuel tank, having a support which is provided in the fuel tank for fastening purposes, having a float which tracks the level of fuel in the fuel tank, and having a bracket (11) which is mounted on the support and is connected to the float, and having an electrical detection unit for generating electrical signals as a function of the position of the bracket, characterized in that the support (12) has a base body (14) and cover (15) which is connected to the base body (14), in that the base body (14) is provided in the fuel tank (1) for fastening purposes.

2. The lever-type transmitter as claimed in claim 1, characterized in that the enclosure has a cover (15), and in that the base body (14) has an edge (25) which rests against adjacent regions of the cover (14).

3. The lever-type transmitter as claimed in claim 1 or 2, characterized in that the connection of the cover (15) to the base body (14) has a latching connection.

4. The lever-type transmitter as defined in claim 3, wherein latching hooks (16) of the base body (14) pass through recesses (26) in the cover (15).

5. The lever-type transmitter as defined in claim 1, wherein the base body (14) and the cover (15) have a bearing pin (18) and/or a bearing shell for the bracket (11).

6. The lever-type transmitter as defined in claim 5, wherein the cover (15) and the base body (14) together define an axial bearing for the bracket (11).

7. The lever-type transmitter as defined in claim 1, wherein the base body (14) and the cover (15) together have an axial guide (20) for the bracket (11), which axial guide is spaced apart from the bearing system of the bracket (11).

8. The lever-type transmitter as defined in claim 1, wherein the cover (15) and the base body (14) have positioning pins (23) and positioning recesses (24) which correspond with one another.
